(19) United States
(12) Patent Application Publication
(10) Pub. No.: US 2005/0252108 A1
(43) Pub. Date: Nov. 17, 2005

(54) Self-cleaning glazing sheet

(76) Inventors: Kevin David Sanderson, Lancashire (GB); James Atherton Knowles, North Somerset (GB)

Correspondence Address: Donald A Schurr;Marshall & Melhorn, 8th Floor, Four SeaGate, Toledo, OH, 43604, US

(21) Appl. No.: 10/497,886

(22) PCT Filed: Dec. 4, 2002
(86) PCT No.: PCT/GB02/05478

§ 371 Date: May 26, 2005

(30) Foreign Application Priority Data
Dec. 8, 2001 (GB) 0129434.1

(51) Int. Cl. E06B 7/00

(52) U.S. Cl. 52/171.3

(57) ABSTRACT

A self-cleaning glazing sheet, preferably of glass, comprises a substrate, a hydrophilic coating on a surface of the substrate, and heating means for raising the temperature of the self-cleaning glazing sheet above the temperature of a self-cleaning glazing sheet having no heating means. Preferably, the hydrophilic coating is photocatalytically active, most preferably of titanium oxide. The preferred heating means comprises a tinted glass substrate which can use incident radiant energy to raise the temperature of the substrate. Multiple glazing units and laminates comprising a self-cleaning glazing sheet and heating means are also disclosed.

This invention relates to self-cleaning glazing sheets, to multiple glazing units or laminates comprising self-cleaning glazing sheets and windows and facades comprising self-cleaning glazing sheets.

Self-cleaning glazing sheets have a hydrophilic surface. Rain or other water which contacts the hydrophilic surface will spread over the surface and wash dirt away from it. It is beneficial to glaze windows with self-cleaning glazing sheets because they require less cleaning than ordinary windows. Self-cleaning glazing sheets may be plastic sheets, but are more usually glass sheets. The self-cleaning surface is usually provided by a hydrophilic coating on the glazing sheet. The coating may, for example, be of silicon oxide or a metal oxide.

A particularly useful type of self-cleaning glazing sheet is one whose hydrophilic coating is photocatalytically active. Photocatalytic activity arises by the photogeneration, in a semiconductor, of a hole-electron pair when the semiconductor is illuminated by light of a particular frequency. The hole-electron pair can be generated in sunlight and can react in humid air to form hydroxy and peroxy radicals on the surface of the semiconductor. The radicals oxidise organic grime on the surface. Photocatalytically active coatings when illuminated thus tend to destroy organic grime on the surface. They also tend to maintain their hydrophilic properties because of the active cleaning of the surface as a consequence of illumination. Photocatalytically active coatings may comprise a semi-conductor with a suitable band gap, for example, titanium oxide.

Titanium oxide photocatalytic coatings on glass are disclosed in EP 0 901 991 A2, WO 97/07069, WO 97/10186, WO 98/06675, WO 98/41480, WO 00/75087, in Abstract 735 of 187th Electrochemical Society Meeting (Reno, Nev., 95-1, p. 1102) and in New Scientist magazine (26 Aug. 1995, p. 19).

It would be advantageous to maintain the hydrophilic nature of surfaces at a level higher than that presently achieved so as to increase the effectiveness of the self cleaning properties. For a photocatalytically active coating, this could entail increasing the photocatalytic activity of the surface.

The present invention accordingly provides, in a first aspect, a self-cleaning glazing sheet comprising a substrate, a hydrophilic coating on a surface of the substrate, and heating means for raising the temperature of the self-cleaning glazing sheet.

The hydrophilic coating is preferably a photocatalytically active coating.

Surprisingly, raising the temperature of the substrate results in the activity of the coating increasing which results in an improvement in the self-cleaning properties of the coating.

The heating means may comprise a powered heater, for example an electrically powered heater. Suitable means may include those having electrically conductive coatings on a surface of the self cleaning glazing sheet or fine wires to be used as heating elements associated with the self cleaning glazing sheet.

However, the heating means will preferably comprise passive heating means, more preferably means for using incident radiant energy (e.g. sunlight) to raise the temperature of the substrate above the temperature of a substrate having no heating means. This is advantageous because it obviates the need for a separate power supply and is efficient in terms of cost and environmental impact. The heating means may comprise a heat-reflecting coating on the other surface of the substrate, or a heat-absorbing coating on a surface of the substrate, but more preferably the heating means comprises a tinted substrate, in particular a tinted glass substrate. Thus, in a preferred embodiment, this aspect of the invention provides a self-cleaning glazing sheet comprising a tinted glass substrate having a hydrophilic coating on a surface of the substrate. Hydrophilic coatings generally have static water contact angles of 40° or lower preferably 25° or lower. The hydrophilic coating is preferably a photocatalytically active coating he substrate preferably has a direct solar heat absorption of 0.15 or greater. More preferably, however, the substrate will have a direct solar heat absorption of 0.2 or greater, 0.25 or greater, 0.3 or greater, 0.35 or greater, or 0.4 or greater. The substrate may be a plastics substrate (for example of polycarbonate), but preferably the substrate will be a glass substrate in particular a float glass substrate. Tinted glass substrates may be formed by adding colourants to base glass compositions. Such colourants include iron oxide which may be added to a base glass composition in an amount of 0.1 to 0.9 weight percent, preferably 0.4 to 0.9 weight percent (Fe₂O₃).

Self-cleaning glazing sheets may be used in multiple glazing units comprising the self-cleaning glazing sheet in opposed orientation to a second glazing sheet. In this case, the multiple glazing unit may itself comprise heating means. The heating means may comprise for example, heating means as described above in relation to the first aspect of the invention or, additionally or alternatively, the second glazing sheet in a multiple glazing unit may comprise heating means, for example a heat reflecting coating. Thus, in a second aspect the present invention provides a multiple glazing unit comprising a self-cleaning glazing sheet, a second glazing sheet in opposed orientation to the self-cleaning glazing sheet and heating means for raising the temperature of the self-cleaning glazing sheet above the temperature of a self-cleaning glazing sheet having no heating means. Preferably, the heating means in this aspect comprises a heat reflecting coating on a surface of the second glazing sheet.

Self-cleaning glazing sheets may also be incorporated in laminates (especially laminated glass). Thus, in a third aspect, the present invention provides a laminate comprising a first ply of a self-cleaning glazing sheet, a second glass ply, a plastic interlayer e.g. of polyvinyl butyral, (PVB) and heating means for raising the temperature of the laminate.

Self-cleaning glazing sheets, multiple glazing units and laminates as described above can be incorporated in windows for buildings or vehicles. Self-cleaning glass sheets, multiple glazing units and laminates as described above can also be incorporated in facades for buildings

In a fourth aspect the present invention provides a window comprising a self-cleaning glazing sheet, the window having associated with it air-flow reducing means arranged to reduce the flow of air over the window. This is advantageous because air-flow reducing means reduce the flow of air over a window and thereby reduce convection cooling of the window (maintaining a higher temperature and therefore higher activity of the self-cleaning glazing sheet). The air-flow reducing means may comprise at least one baffle or at least one wind deflector.

By way of example, embodiments of the invention will now be described with reference to the accompanying drawings in which:

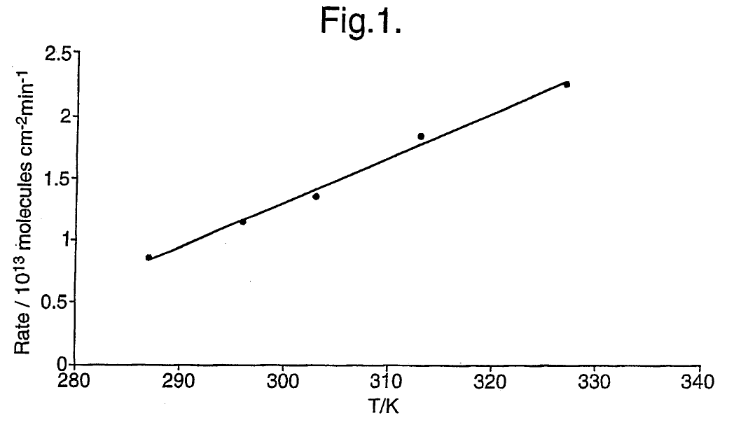

FIG. 1 is a graph of rate of reaction of a photocatalytically active coating of titanium oxide on glass as a function of temperature.

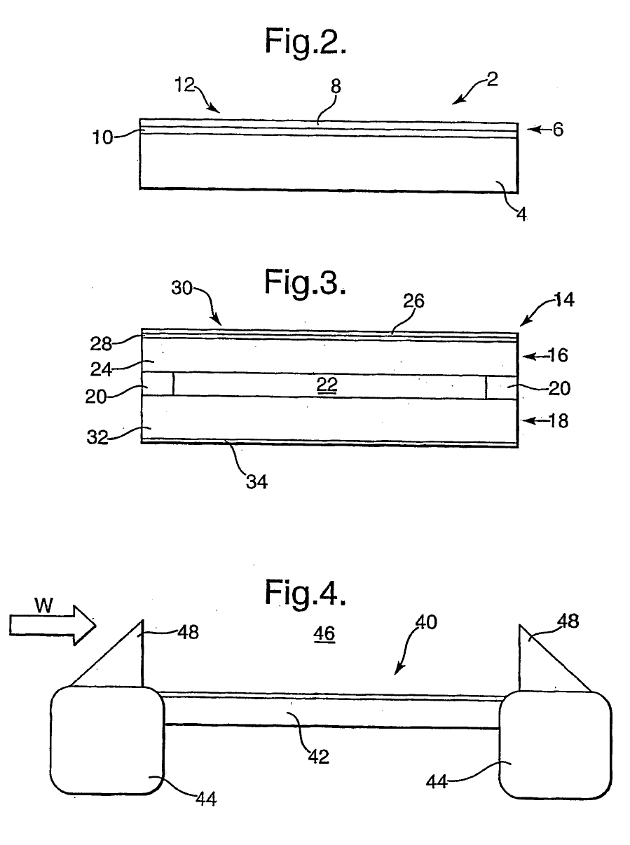

FIG. 2 illustrates schematically in section (and not to scale) a self-cleaning glazing sheet according to the present invention.

FIG. 3 illustrates schematically in section (and not to scale) a multiple glazing unit comprising a self-cleaning glazing sheet.

FIG. 4 illustrates schematically in section (and not to scale) a window comprising a self-cleaning glazing unit in a structure having wind deflectors.

The data for FIG. 1 were obtained using a clear float glass substrate provided with a coating having an alkali blocking under-layer of silica and a photocatalytically active coating of titanium oxide deposited over the silica layer. The silica and titanium oxide layers were deposited by chemical vapour deposition on the glass surface during the float glass production process; the silica coating from a precursor gas mixture comprising silane, ethylene and oxygen, the titanium oxide layer from a precursor gas mixture comprising titanium chloride and ethyl acetate (generally as described in WO 00/75087).

To measure the photocatalytic activity of the coated glass, stearic acid films were deposited on the photocatalytically active surface by taking a 1×10⁻² mol dm⁻³ stock solution of stearic acid in methanol and pipetting 3×10⁻² cm³ onto the TiO₂ coated surface of the glass slide. This was then spun at 1000 rpm for 2 min on an Electronic Microsystems Ltd spin coater and subsequently left in an air stream for about 30 min to ensure the complete removal of methanol. The photoactivity of the films were determined by the measuring the characteristic integrated absorbance of the C—H infrared stretching vibrations of stearic acid between 2700 cm⁻¹ and 3000 cm⁻¹ as a function of irradiation time using a Perkin Elmer 1725 Fourier Transform Infrared spectrometer (FTIR). Literature values based on the integrated absorbance of homologs having a known area per molecule (such as arachidic acid (CH₃(CH₂)₁₈CO₂H)) give a value of 3.17×10¹⁵ stearic acid molecules cm⁻² for each abs. cm⁻¹ unit measured (as discussed in Y. Paz, Z. Luo, L. Razenberg, A. Heller, J. Mater. Res., 1995, 10, 2842.). Surface concentrations of stearic acid were calculated on this basis.

Irradiation was done using a photochemical reactor comprising a half cylinder irradiation unit containing six 8 W Black Light bulbs (Coast-Air; radiation λ(max)=355-360 nm; length, 28.7 cm) set against a half cylinder aluminium reflector. In order to determine the effect of temperature, coated glass samples were mounted on a thermostatted cell and the temperature was varied between 14 and 53° C. (287 and 327 K). FIG. 1 shows the rate of stearic acid photooxidation as a function of temperature. From these results it was clear that increasing the temperature increases the rate of reaction.

FIG. 2 shows a self-cleaning glazing sheet 2 comprising a dark green tinted float glass substrate 4 having a two layer coating 6 on one surface. The float glass substrate 4 has a base composition of a soda lime silica glass with about 0.9 weight percent iron oxide as colourant, as described in Tables 1 and 2 below. The upper layer 8 of the coating 6 is a photocatalytically active layer of titanium oxide. The lower layer 10 of the coating 6 is a layer of silica which acts as an alkali blocking layer to reduce or prevent the migration of alkali metal ions into the upper layer 8 of the coating 6 which may reduce its photocatalytic activity. When the glazing sheet 2 is exposed to radiant energy (for example sunlight) the tinted float glass substrate 4 absorbs a part of that energy and the temperature of the glazing sheet 2 rises. The temperature rise has the effect of enhancing the self-cleaning properties of the coated surface 12 of the glazing sheet by increasing the photocatalytic activity of the photocatalytically active layer 8. The temperature rise may also make the surface more hydrophilic.

FIG. 3 shows a double glazing unit 14 comprising a self-cleaning glazing sheet 16 and a second glazing sheet 18 mounted in opposed orientation to it. The self-cleaning glazing sheet 16 and the second glazing sheet 18 are separated by a spacer 20 to leave an air gap 22 to improve the insulation of the unit. The self-cleaning glazing sheet 16 is similar to that illustrated in FIG. 2, comprising a float glass substrate 24 having a two layer coating on one surface. The upper layer 26 of the coating is a photocatalytically active layer of titanium oxide and the lower layer 28 is a layer of silica which acts as an alkali blocking layer. The coated surface 30 of the self-cleaning glazing sheet 16 is positioned so that when the double glazing unit 14 is installed in a structure the coated surface may be on the outside. The second glazing sheet 18 comprises a dark green tinted float glass substrate 32 having a pyrolytically deposited heat-reflecting coating 34 on one surface. The heat reflecting coating comprises a silicon oxycarbide underlayer and a fluorine doped tin oxide layer (of about 300 nm thickness). Alternatively, the heat reflecting layer may comprise a sputtered coating comprising one or more thin layers of silver and anti-reflection layers.

In use, radiant energy (e.g. sunlight) will pass through the double glazing unit 14 and be reflected by the heat reflecting coating 34 towards the self-cleaning glazing sheet 16 thereby increasing its temperature. The dark green glass substrate 32 of the second glazing sheet 18 will also contribute to an increase in the temperature of the self-cleaning glazing sheet 16 by absorbing radiant energy, re-radiated absorbed energy also being reflected by the heat reflecting coating 34 towards the self-cleaning glazing sheet 16.

FIG. 4 shows a window 40 comprising a self-cleaning glazing sheet 42 in a structure. The window 40 is installed in frame members 44. Fixed to the frame members 44 and projecting to the exterior 46 of the structure are angled wind deflectors 48. The wind deflectors 48 are positioned and shaped so as to deflect components of the wind W which are flowing substantially parallel to the surface of the window 40. The results of such deflection is that convective cooling of the window 40 is reduced which results in a higher temperature rise for a given intensity of radiant energy incident on the window. As an alternative to wind deflectors, baffles may be used to slow the wind or other air flow across the window.

The invention is further illustrated by the following examples which relate to self-cleaning glazing sheets comprising photocatalytically active coatings deposited on glass substrates. The glass substrates consist of a base composition having components in the approximate range of proportions indicated in Table 1, tinted by the addition of colourants in the approximate amounts described in Table 2. Usually the colourants are added on top of the base composition, in which case the composition is re-normalised. Amounts are in weight percent, small amounts of other components may also be present. The amount of ferrous iron (Fe²⁺) is measured in optical percent terms. The glass substrates may be made by methods well known in the glass art and clear and tinted glass substrates (with properties identical to or similar to those of the glass substrates described herein) may be purchased as staple commercial products.

TABLE 1
Base Composition

| | | Max |
|---|---|---|
| | Min wt % | wt % |
| SiO₂ | 71.90 | 72.90 |
| CaO | 8.27 | 9.15 |
| MgO | 3.87 | 4.42 |
| Na₂O | 12.90 | 14.20 |
| K₂O | 0.02 | 0.80 |
| Fe₂O₃ | 0.092 | 0.136 |
| Al₂O₃ | 0.07 | 1.19 |
| SO₃ | 0.167 | 0.25 |

TABLE 2

| Colour of | | | | | | |
|---|---|---|---|---|---|---|
| tinted glass | Fe₂O₃ | Fe²⁺ (% | Co₃O₄ | NiO | Se | TiO₂ |
| substrate | (wt %) | Optical) | (ppm) | (ppm) | (ppm) | (wt %) |
| Clear | — | — | — | — | — | — |
| Grey | 0.40 | 20 | 80 | — | 23 | — |
| Bronze | 0.40 | 20 | 39 | — | 27 | — |
| Blue | 0.61 | 27 | 57 | — | — | 0.11 |
| Light Green | 0.60 | 25 | — | — | — | — |
| Dark Green | 0.90 | 25 | — | — | — | — |

The tinted glasses have amounts of iron oxide (measured as Fe₂O₃ weight percent) in the range 0.4 to 0.9 (but may have amounts in a broader range, for example, 0.1 to 0.9) and amounts of ferrous iron in the range about 20 to 30% optical.

The optical properties of visible transmission, transmission colour (L*, a*, b*, illuminant D65) direct solar reflection and direct solar absorption for 6 mm thick samples of the clear and tinted float glass having components in the ranges described in Tables 1 and 2 are described in table 3 below. Values of visible transmission, direct solar reflection and direct solar absorption were calculated in accordance with ISO 9050. The solar values were calculated using air mass 2.

TABLE 3

| | Visible | Transmission | | | | |
|---|---|---|---|---|---|---|
| | trans- | Colour | | | Direct Solar | Direct Solar |
| Tint of glass | mission | (D65) | | | Reflection | Absorption |
| substrate | (%) | L* | a* | b* | (%) | (%) |
| Clear | 88.9 | 95.5 | −1.9 | 0.2 | 7.2 | 13.8 |
| Grey | 43.0 | 71.5 | 1.2 | −1.8 | 5.2 | 49.6 |
| Bronze | 48.4 | 75.1 | 3.0 | 7.9 | 5.2 | 49.2 |
| Blue | 54.9 | 79.0 | −9.5 | −10.7 | 5.0 | 60.0 |
| Light Green | 75.1 | 89.4 | −9.2 | 1.2 | 5.5 | 50.0 |
| Dark Green | 65.0 | 84.5 | −13.1 | 2.5 | 5.1 | 62.0 |

The optical properties of glass vary with thickness of the glass sample. The direct solar absorption of light green tinted glass is shown in Table 4 as a function of thickness.

TABLE 4

| Thickness of Light | Direct Solar |
|---|---|
| Green Glass Substrate | Absorption |
| (mm) | (%) |
| 4 | 39.6 |
| 2 | 24.2 |
| 1.5 | 19.1 |

The photocatalytically active coatings (deposited as described in WO00/75087) comprise a two layer coating: an underlayer of silicon oxide and a photocatalytically active layer of titanium oxide (in the anatase form). The silicon oxide under-layer may be deposited by causing a gaseous mixture of silane, oxygen, ethylene and nitrogen (for example at a flow ratio of 1:2:6:0.13) to contact and flow parallel to the glass surface in the direction of movement of the glass at a glass temperature of approximately 670° C. The thickness of the silicon oxide coating may, for example, be in the range 25 to 40 nm. The photocatalytically active titanium oxide layer may be deposited by combining gas streams comprising titanium tetrachloride in flowing nitrogen carrier gas, ethyl acetate in flowing nitrogen carrier gas and a bulk flow of nitrogen into a gaseous mixture and then causing the gaseous mixture to contact and flow over the glass surface at a glass temperature of about 640° C. The thickness of the titanium oxide layer may, for example, be in the range 10 to 20 nm. Photocatalytically active coatings may be formed from a variety of metal compounds. Compounds which have been proposed as useful include titanium oxides, iron oxides, silver oxides, copper oxides, tungsten oxides, zinc oxides, zinc/tin oxides and strontium titanates.

Other methods of deposition of the photocatalytically active coating may be used. Photocatalytically active coatings of titanium oxide may be deposited by chemical vapour deposition (CVD) using other titanium precursors, for example titanium alkoxides (e.g. titanium ethoxide or titanium propoxide), sol gel methods (e.g. dip, flow or spin coating using alkoxide precursors in alcohols), sputtering (including reactive sputtering using a titanium metal or substoichiometric oxide target) or other coating methods. The coatings once deposited may be further processed (e.g. to increase the photocatalytic activity of the coating) for example by heat treatment. The coating may comprise coating layers other than the photocatalytically active coating to modify, for example, the hydrophilic, optical or other properties of the coating or to protect the coating (e.g. by blocking migration of alkali metal ions from the substrate if the substrate contains mobile alkali metal ions).

In the following examples, the centre pane temperature of self-cleaning glazing sheets having heating means of various kinds is calculated under different conditions (see the International Organisation for Standards ISO 9050 and/or ISO 9845). The general conditions used relate to exposure of the glazing sheets under ISO conditions and under ASHRAE (American Society of Heating Refrigerating and Air Conditioning Engineers) Summer conditions. These conditions are described in Table 5, below. The uncertainty in the temperature calculations is about ±1° C.

TABLE 5

| | ISO exposure | | ASHRAE Summer exposure | |
|---|---|---|---|---|
| Wind speed | 3.5 | m/s | 3.5 | m/s |
| Radiation intensity | 750 | W/m² | 783 | W/m² |
| External temperature | 10° | C. | 31.7° | C. |
| Internal temperature | 10° | C. | 23.9° | C. |

### EXAMPLES 1 TO 5

Examples 1 to 5 relate to single glazing sheets where the glass substrate is 6 mm thick and the photocatalytically active coating is on the outside surface (i.e. towards the radiant source). The substrates are of various tints. The temperatures of the glazing sheets are described in Table 6 for ISO and ASHRAE Summer conditions.

TABLE 6

| | | | ASHRAE |
|---|---|---|---|
| | | | Summer |
| | Tint of Glass | ISO Exposure | Exposure |
| Example | Substrate | (° C.) | (° C.) |
| 1 | Bronze | 21.9 | 41.8 |
| 2 | Grey | 21.9 | 41.8 |
| 3 | Blue | 23.9 | 44.7 |
| 4 | Light Green | 22.1 | 42.7 |
| 5 | Dark Green | 24.5 | 45.4 |

### EXAMPLES 6 TO 10

Examples 6 to 10 relate to double glazing units where each of the two (glass) substrates is 6 mm thick and there is a 12.7 mm air gap between them. In each unit, the self-cleaning glazing sheet is orientated so that the photocatalytically active coating is on the outside surface (i.e. towards the radiant source). The second glazing sheet is clear. The self-cleaning substrates are of various tints. The temperatures of the self-cleaning glazing sheets are described in Table 7 for ISO and ASHRAE Summer conditions.

TABLE 7

| | | | ASHRAE |
|---|---|---|---|
| | Tint of Glass | ISO | Summer |
| Example | Substrate | (° C.) | (° C.) |
| 6 | Bronze | 24.4 | 46.4 |
| 7 | Grey | 24.1 | 45.3 |
| 8 | Blue | 26.5 | 48.4 |
| 9 | Light Green | 24.4 | 46.4 |
| 10 | Dark Green | 27.1 | 49.2 |

### EXAMPLES 11 TO 15

Examples 11 to 15 relate to self-cleaning glazing sheets having a dark green glass substrate as in Example 5 with the glass substrate having a varying thickness (between 6 mm and 1 mm). The temperatures of the self-cleaning glazing sheets are described in Table 8 for ISO and ASHRAE Summer conditions together with the direct solar absorption (determined on the coated side).

TABLE 8

| | Thickness of Dark | Direct Solar | | |
|---|---|---|---|---|
| | Green Glass | Absorption | | ASHRAE |
| | Substrate | (coated side) | ISO | Summer |
| Example | (mm) | (%) | (° C.) | (° C.) |
| 11 | 6 | 59.1 | 24.4 | 45.4 |
| 12 | 4 | 49.2 | 22 | 42 |
| 13 | 2 | 32.3 | 17.8 | 37.8 |
| 14 | 1.5 | 26.1 | 16.4 | 36.2 |
| 15 | 1 | 18.9 | 14.6 | 34.4 |

### EXAMPLES 16 TO 33

Examples 16 to 33 in Table 9 and 10 show the effect on the temperatures of self-cleaning glazing sheets on clear (Examples 16 to 24) or dark green glass (Examples 17 to 33) substrates in double glazing units of changing the wind speed. The second glazing sheet in each unit is of clear 6 mm thick glass, 12.7 mm air gap. The other conditions used to calculate the temperatures correspond to the ISO or ASHRAE Summer conditions.

TABLE 9

| | |
|---|---|
| Wind | Clear Glass Substrate |

| | speed | ISO | ASHRAE Summer |
|---|---|---|---|
| Example | (m/s) | (° C.) | (° C.) |
| 16 | 0.0 | 22 | 42 |
| 17 | 0.5 | 20 | 40 |
| 18 | 1.0 | 19 | 39 |
| 19 | 1.5 | 18 | 38 |
| 20 | 2.0 | 17 | 38 |
| 21 | 2.5 | 16 | 37 |
| 22 | 3.0 | 16 | 37 |
| 23 | 3.5 | 15 | 36 |
| 24 | 4.0 | 15 | 36 |

TABLE 10

| | |
|---|---|
| Wind | Dark Green Glass Substrate |

| | speed | ISO | ASHRAE Summer |
|---|---|---|---|
| Example | (m/s) | (° C.) | (° C.) |
| 25 | 0.0 | 49 | 70 |
| 26 | 0.5 | 44 | 64 |
| 27 | 1.0 | 40 | 60 |
| 28 | 1.5 | 36 | 57 |
| 29 | 2.0 | 34 | 55 |
| 30 | 2.5 | 31 | 52 |
| 31 | 3.0 | 30 | 51 |
| 32 | 3.5 | 27 | 49 |
| 33 | 4.0 | 27 | 48 |

1. A self-cleaning glazing sheet comprising a substrate, a hydrophilic coating on a surface of the substrate, and a heating system for raising the temperature of the substrate.

2. A self-cleaning glazing sheet as claimed in claim 1, wherein the heating system comprises a passive heating means.

3. A self-cleaning glazing sheet as claimed in claim 1, wherein the heating system comprises means for using incident radiant energy to raise the temperature of the substrate.

4. A self-cleaning glazing sheet as claimed in claim 1, wherein the heating system comprises a heat-reflecting coating on the other surface of the glazing sheet.

5. A self-cleaning glazing sheet as claimed in claim 1, wherein the heating system comprises a heat-absorbing coating on a surface of the sheet.

6. A self-cleaning glazing sheet as claimed in claim 1, wherein the substrate is a tinted glass.

7. A self-cleaning glazing sheet as claimed in claim 1, wherein the substrate has a direct solar heat absorption of 0.15 or greater.

8. A self-cleaning glazing sheet as claimed in claim 1, wherein the hydrophilic coating comprises a photocatalytically active coating.

9. A self-cleaning glazing sheet comprising a tinted glass substrate having a photocatalytically active coating on a surface.

10. A multiple glazing unit comprising a self-cleaning glazing sheet as claimed in claim 1 and a second glazing sheet in opposed orientation to the self-cleaning glazing sheet.

11. A multiple glazing unit comprising a self-cleaning glazing sheet, a second glazing sheet in opposed orientation to the self-cleaning glazing sheet and a heating system for raising the temperature of the self-cleaning glazing sheet

12. A multiple glazing unit as claimed in claim 11, wherein the heating system comprises a heat reflecting coating on a surface of the second glazing sheet.

13. A laminate comprising a first ply of a self-cleaning glazing sheet, a second glass ply and a plastic interlayer and a heating system for raising the temperature of the laminate.

14. A window comprising a self-cleaning glazing sheet as claimed in claim 1.

15. A window comprising a self-cleaning glazing sheet, the window having associated with it an air-flow reducing system arranged to reduce the flow of air over the window.

16. A window as claimed in claim 15 wherein the air-flow reducing system comprises at least one baffle.

17. A window as claimed in claim 15 wherein the air-flow reducing system comprises at least one wind deflector.

18. A facade for a building comprising a plurality of self-cleaning glazing sheets as claimed in claim 1.

19. (canceled)

20. (canceled)

21. A window comprising a multiple glazing unit as claimed in claim 11.

22. A window comprising a laminate as claimed in claim 13.

23. A facade for a building comprising a plurality of multiple glazing units as claimed in claim 11.

24. A facade for a building comprising a plurality of laminates as claimed in claim 13.
